(19) United States
(12) Patent Application Publication
(10) Pub. No.: US 2015/0314724 A1
(43) Pub. Date: Nov. 5, 2015

(54) ILLUMINATED VEHICLE INTERIOR COMPONENT HAVING AN ELASTOMERIC MATERIAL

(71) Applicant: JOHNSON CONTROLS TECHNOLOGY COMPANY, Holland, MI (US)

(72) Inventor: Ronald A. Bozio, Holland, MI (US)

(21) Appl. No.: 14/649,791

(22) PCT Filed: Dec. 5, 2013
(86) PCT No.: PCT/US2013/073329

§ 371 Date: Jun. 4, 2015

Related U.S. Application Data
(60) Provisional application No. 61/733,543, filed on Dec. 5, 2012.

(51) Int. Cl. B60Q 3/02; B60Q 3/00; B60R 7/06

(52) U.S. Cl. CPC B60Q 3/02; B60R 7/06; B60Q 3/002

(57) ABSTRACT

An illuminated vehicle interior component having a support configured to be mounted to a vehicle interior. The support includes a show surface, a rear surface, and at least one aperture extending between the rear surface and the show surface. The illuminated vehicle interior component also includes an elastomeric material disposed in the at least one aperture of the support. The elastomeric material is configured to receive light from a light source and to direct the light through the elastomeric material from the rear surface to the show surface.

### CROSS REFERENCE TO RELATED APPLICATION

This application claims priority from and the benefit of U.S. Provisional Application Ser. No. 61/733,543, entitled “ILLUMINATED VEHICLE INTERIOR COMPONENT HAVING AN ELASTOMERIC MATERIAL”, filed Dec. 5, 2012, which is hereby incorporated by reference in its entirety.

### BACKGROUND

The invention relates generally to motor vehicles, and more particularly, to an illuminated vehicle interior component having an elastomeric material.

Vehicles typically include a variety of lighting systems to illuminate various regions of a vehicle interior. For example, certain vehicles include one or more lights configured to illuminate devices in an instrument panel of the vehicle. Furthermore, certain vehicles include one or more lights configured to illuminate devices at other locations throughout the vehicle interior. Such lights may illuminate panels, trays, cup holders, handles, switches, indicators, controls, and so forth. As may be appreciated, lighting systems may provide illumination for enabling a driver to operate the vehicle in low-light conditions. Moreover, lighting systems may provide decorative illumination, which is visible during daytime and/or nighttime operation. These lighting systems may use a light-emitting device positioned to illuminate a component, such as by positioning the light-emitting device behind the component (e.g., for backlighting the component). Accordingly, the light-emitting device may emit light through layers of the component to illuminate the component. Unfortunately, such illuminated vehicle interior components may be expensive to manufacture.

### BRIEF DESCRIPTION OF THE INVENTION

The present invention relates to an illuminated vehicle interior component having a support configured to be mounted to a vehicle interior. The support includes a show surface, a rear surface, and at least one aperture extending between the rear surface and the show surface. The illuminated vehicle interior component also includes an elastomeric material disposed in the at least one aperture of the support. The elastomeric material is configured to receive light from a light source and to direct the light through the elastomeric material from the rear surface to the show surface.

The present invention also relates to an illuminated vehicle tray assembly having a support comprising a show surface, a rear surface, and a plurality of apertures each extending between the rear surface and the show surface. The illuminated vehicle tray assembly also includes an elastomeric material disposed in each of the plurality of apertures of the support. The illuminated vehicle tray assembly includes a substrate coupled to the rear surface of the support. The illuminated vehicle tray assembly also includes a light source coupled to the substrate, and configured to direct light toward the elastomeric material. The elastomeric material is configured to receive light from the light source and to direct the light through the elastomeric material from the rear surface to the show surface.

The present invention further relates to a method for manufacturing an illuminated vehicle interior component. The method includes forming a plurality of apertures in a support and injection molding an elastomeric material configured to be disposed in the plurality of apertures. The elastomeric material is configured to receive light from a light source and to direct the light through the elastomeric material from a rear surface of the support to a show surface of the support.

### DRAWINGS

FIG. 1 is a perspective view of an exemplary vehicle that may include an illuminated vehicle interior component.

FIG. 2 is a perspective view of an embodiment of an illuminated vehicle interior component.

FIG. 3 is a cross-sectional view of an embodiment of an illuminated vehicle interior component.

FIG. 4 is a cross-sectional view of another embodiment of an illuminated vehicle interior component.

FIG. 5 is a flowchart of an embodiment of a method for manufacturing an illuminated vehicle interior component.

### DETAILED DESCRIPTION

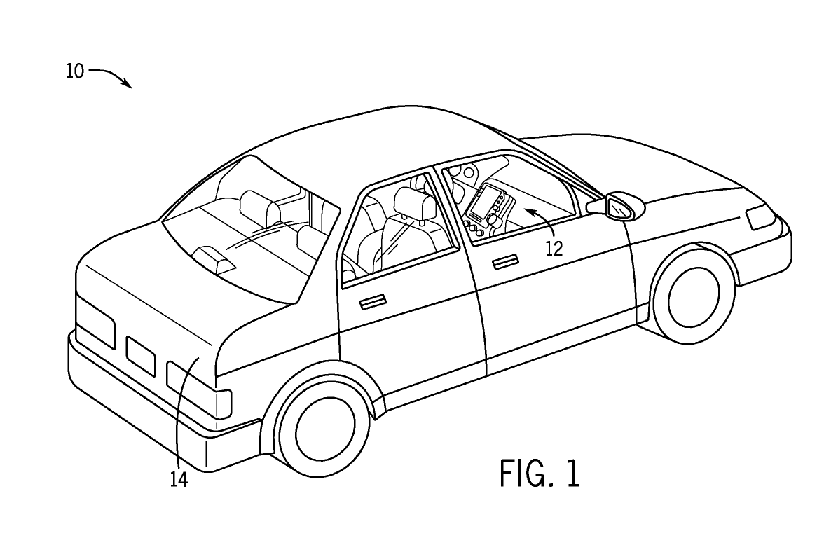

FIG. 1 is a perspective view of an exemplary vehicle 10 that may include an illuminated vehicle interior component, such as an illuminated panel, tray, cup holder, handle, switch, indicator, control, and so forth. The vehicle 10, in this case a car, includes an interior 12 and an exterior 14. The illuminated vehicle interior component may be located in the interior 12 or on the exterior 14 of the vehicle 10. Furthermore, the illuminated vehicle interior component may be manufactured to provide illumination through an elastomeric material of the vehicle interior component. For example, illumination may be provided through friction-resisting components of the vehicle interior component, thereby enabling the friction-resisting components to have a dual purpose (e.g., blocking movement of objects and directing light therethrough). Moreover, by using dual-purpose components to provide illumination, the illuminated vehicle interior component may be manufactured with less cost than traditional illuminated vehicle interior components.

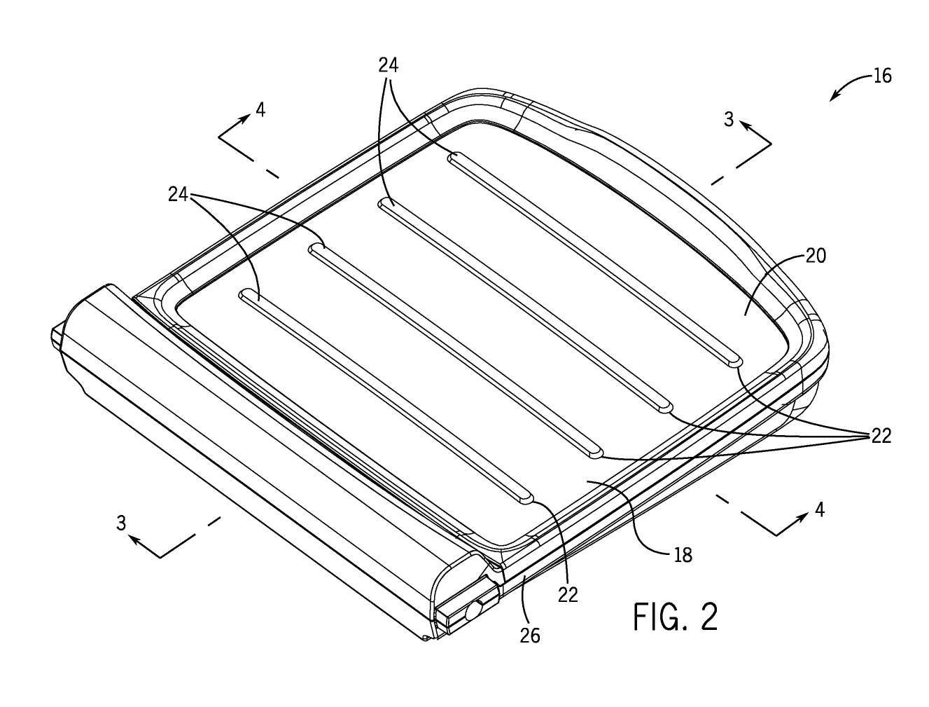

FIG. 2 is a perspective view of an embodiment of an illuminated vehicle interior component 16, such as the illustrated tray for a floor console. The illuminated vehicle interior component 16 includes a support 18 that may be mounted to the interior 12 or to the exterior 14 of the vehicle 10. The support 18 includes a show surface 20 and a rear surface opposite the show surface 20. Elongated apertures 22 extend through the support 18 between the show surface 20 and the rear surface. The support 18 may be manufactured using any suitable material. For example, the support 18 may be manufactured from any combination of wood, metal, plastic, polymer, or any other suitable material. In certain embodiments, the support 18 may be a wood panel.

An elastomeric material 24 is disposed in the apertures 22 of the support 18 and may be used to block movement of objects placed on the show surface 20 of the support 18. For example, in certain embodiments, the elastomeric material 24 may act as friction strips. The elastomeric material 24 may be manufactured using any suitable material. For example, the elastomeric material 24 may include an injected molded elastomer, a thermoplastic elastomer (TPE), a light-transmissive material, and/or a dark tinted material. In certain embodiments, the elastomeric material 24 may appear dark or opaque when not illuminated. The elastomeric material 24 is configured to receive light from a light source and to direct the light through the elastomeric material 24 from the rear surface of the support 18 to the show surface 20 of the support 18.

In addition, the elastomeric material 24 may be composed of a material particularly selected to provide durability, while maintaining an elastic texture. As will be appreciated, flexibility and durability of the elastomeric material 24 may be measured by determining the hardness of the constituent material. One measure of hardness is the resistance to indentation, otherwise referred to as Durometer, denoted in the Shore A scale, for example. Within the Durometer scale, materials are generally characterized based on ranges. Hard or rigid elastomers generally include those having a Durometer greater than about 90 Shore A, soft elastomers generally include those having a Durometer of about 60 Shore A to about 90 Shore A, and super-soft elastomers generally include those having a Durometer below about 60 Shore A. In certain embodiments, the elastomeric material 24 may be composed of a material having a Durometer of less then approximately 90 Shore A. Utilizing such a material may facilitate increasing the friction of the show surface 20, while maintaining durability and smoothness of the show surface 20.

As may be appreciated, in certain embodiments, the support 18 and the elastomeric material 24 may be integrally formed by an injection molding process. As illustrated, the support 18 is coupled to a substrate 26. The substrate 26 may provide structural support to the support 18 and may facilitate mounting of lighting devices, such as a printed circuit board (PCB), a light source (e.g., light emitting diode (LED)), a light guide, and so forth.

Using the techniques discussed above, the illuminated vehicle interior component 16 may be manufactured such that the elastomeric material 24 appears to be an opaque friction providing strip when not illuminated. Furthermore, the elastomeric material 24 may be illuminated to provide an ambient glow and to add decorative effect to the illuminated vehicle interior component 16. Thus, the elastomeric material 24 of the illuminated vehicle interior component 16 may provide a dual functionality of a friction-inducing surface and a source of illumination. As such, the aesthetic appeal of the illuminated vehicle interior component 16 may be enhanced without significantly increasing manufacturing cost.

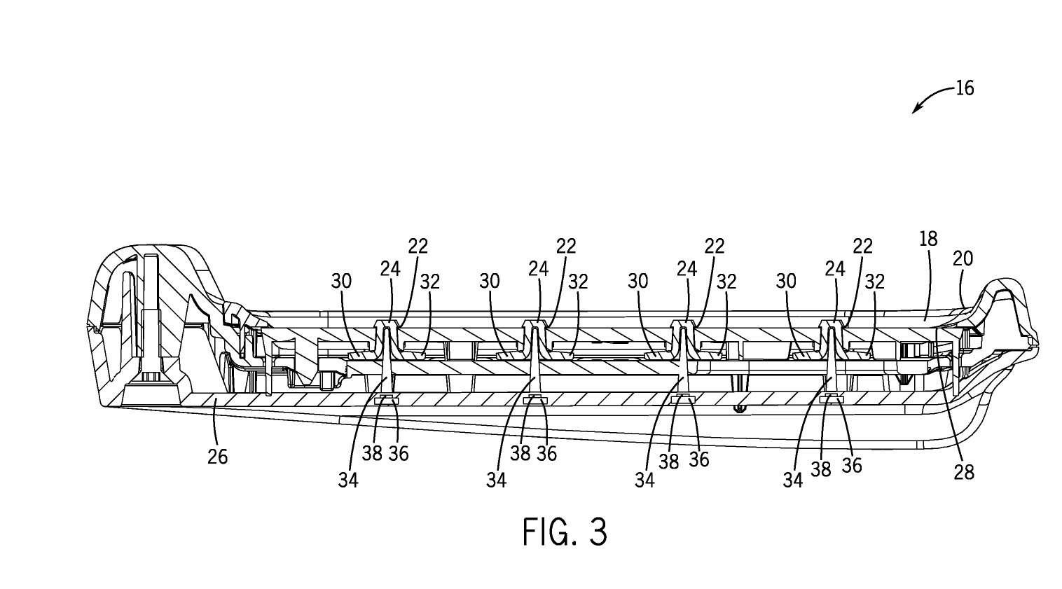

FIG. 3 is a cross-sectional view of an embodiment of the illuminated vehicle interior component 16. As illustrated, the support 18 includes a rear surface 28 opposite the show surface 20. Furthermore, the elastomeric material 24 extends between the show surface 20 and the rear surface 28. The elastomeric material 24 includes legs 30 and 32 that extend under the rear surface 28 to hold the elastomeric material 24 in place. A light guide 34 is positioned behind each aperture 22 and directs light from a light source toward the elastomeric material 24. In the illustrated embodiment, each printed circuit board 36 includes a light source 38 (e.g., LED) to emit light toward the elastomeric material 24 in the light guides 34. Accordingly, light emitted from the light source 38 is directed through the light guides 34 to the elastomeric material 24. Moreover, the light is directed through the elastomeric material 24 from the rear surface 28 to the show surface 20 of the support 18. As such, the elastomeric material 24 is illuminated.

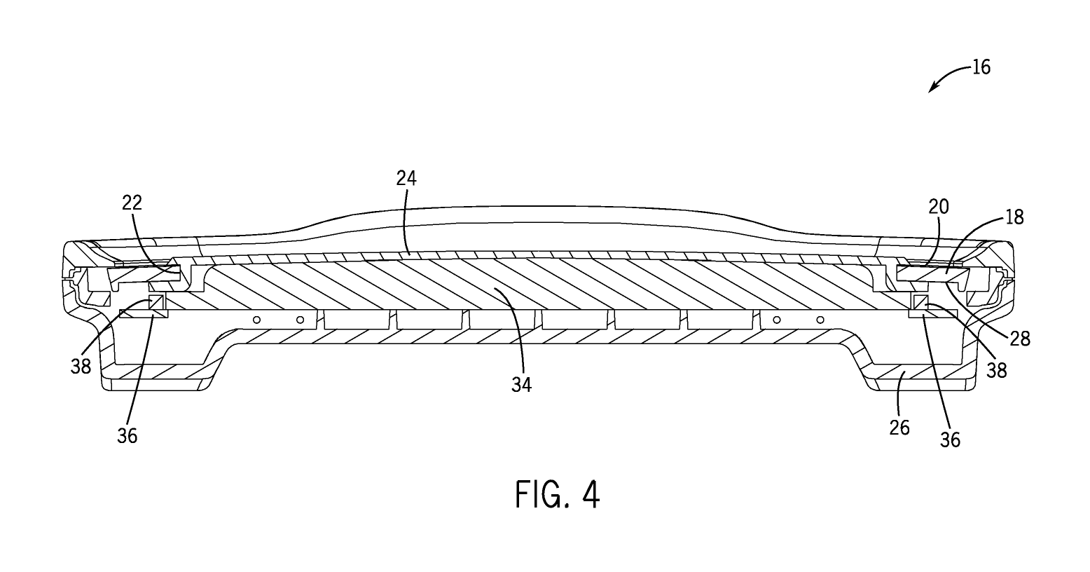

FIG. 4 is a cross-sectional view of another embodiment of the illuminated vehicle interior component 16. As illustrated, the light sources 38 are side firing LEDs. Accordingly, the light guide 34 directs light emitted from the side firing LEDs toward the elastomeric material 24. While two light sources 38 are illustrated, the illuminated vehicle interior component 16 may include fewer or more light sources 38 for each aperture 22. In certain embodiments, the light sources 38 may emit light upward, sideways, or in any suitable direction. Therefore light may be emitted from the light sources 38 toward the elastomeric material 24.

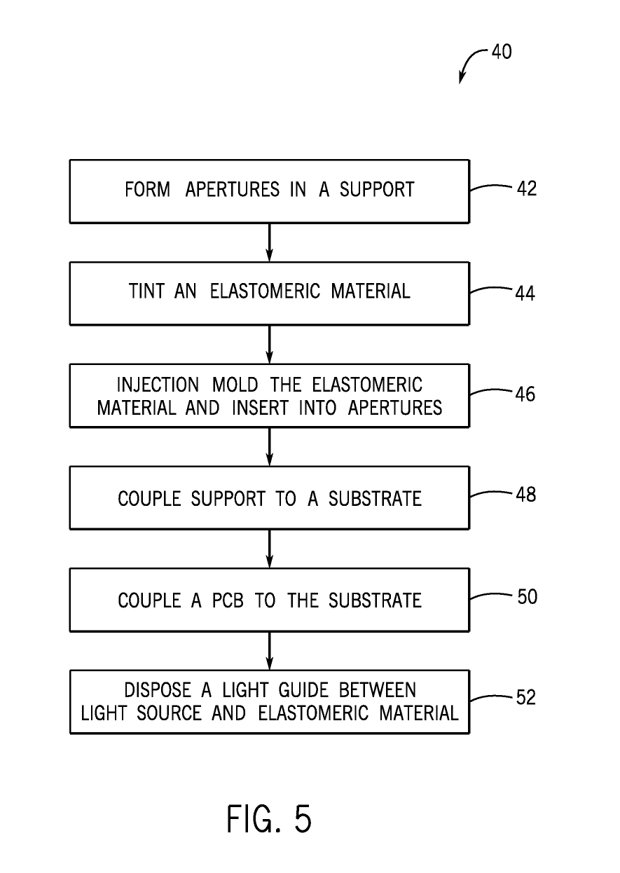

FIG. 5 is a flowchart of an embodiment of a method 40 for manufacturing the illuminated vehicle interior component 16. Apertures (e.g., apertures 22) are formed in a support (e.g., support 18) (block 42). In some embodiments the apertures may be formed by removing material from the support, while in other embodiments the apertures may be formed by a molding process used to manufacture the support. In certain embodiments, the elastomeric material (e.g., elastomeric material 24) may be tinted with a light transmissive tint (block 44). For example, the elastomeric material may be tinted to appear dark when not illuminated, such as by using a smoke colored tint. The elastomeric material is injection molded separately from the apertures and thereafter inserted into the apertures (block 46). However, in other embodiments, the elastomeric material is injection molded directly into the apertures. As discussed above, the elastomeric material is configured to receive light from a light source and to direct the light through the elastomeric material from a rear surface of the support to a show surface of the support.

The support is coupled to a substrate (e.g., substrate 26) (block 48). The substrate provides structural support to the support and may be used for mounting a light source. For example, in certain embodiments a printed circuit board (e.g., PCB 36) is coupled to the substrate (block 50). The PCB includes the light source (e.g., light source 38), which is configured to direct light toward the elastomeric material. A light guide (e.g., light guide 34) may be disposed between the light source and the elastomeric material to direct light from the light source toward the elastomeric material (block 52).

Using the techniques described herein, the illuminated vehicle interior component 16 may be manufactured such that the elastomeric material 24 appears to be opaque when not illuminated. Furthermore, the elastomeric material 24 may be illuminated to provide an ambient glow and add decorative effect to the illuminated vehicle interior component 16. Moreover, in certain embodiments, the elastomeric material 24 may also be used to increase the friction of the illuminated vehicle interior component 16. Thus, the elastomeric material 24 of the illuminated vehicle interior component 16 may provide a dual functionality of a friction inducing surface and a source of illumination. As such, the aesthetic appeal of the illuminated vehicle interior component 16 may be enhanced without significantly increasing manufacturing cost.

While only certain features and embodiments of the invention have been illustrated and described, many modifications and changes may occur to those skilled in the art (e.g., variations in sizes, dimensions, structures, shapes and proportions of the various elements, values of parameters (e.g., temperatures, pressures, etc.), mounting arrangements, use of materials, colors, orientations, etc.) without materially departing from the novel teachings and advantages of the subject matter recited in the claims. The order or sequence of any process or method steps may be varied or resequenced according to alternative embodiments. It is, therefore, to be understood that the appended claims are intended to cover all such modifications and changes as fall within the true spirit of the invention. Furthermore, in an effort to provide a concise description of the exemplary embodiments, all features of an actual implementation may not have been described (i.e., those unrelated to the presently contemplated best mode of carrying out the invention, or those unrelated to enabling the claimed invention). It should be appreciated that in the development of any such actual implementation, as in any engineering or design project, numerous implementation specific decisions may be made. Such a development effort might be complex and time consuming, but would nevertheless be a routine undertaking of design, fabrication, and manufacture for those of ordinary skill having the benefit of this disclosure, without undue experimentation.

1. An illuminated vehicle interior component comprising:
a support configured to be mounted to a vehicle interior, wherein the support comprises a show surface, a rear surface, and at least one aperture extending between the rear surface and the show surface; and
an elastomeric material disposed in the at least one aperture of the support, wherein the elastomeric material is configured to receive light from a light source and to direct the light through the elastomeric material from the rear surface to the show surface.

2. The illuminated vehicle interior component of claim 1, wherein the support comprises a wood panel.

3. The illuminated vehicle interior component of claim 1, wherein the support comprises a metal, a polymer, or some combination thereof.

4. The illuminated vehicle interior component of claim 1, wherein the at least one aperture comprises a plurality of elongated apertures.

5. The illuminated vehicle interior component of claim 1, wherein the elastomeric material comprises an injection molded elastomer.

6. The illuminated vehicle interior component of claim 1, wherein the support and the elastomeric material are integrally formed by an injection molding process.

7. The illuminated vehicle interior component of claim 1, wherein the elastomeric material comprises a tinted material.

8. The illuminated vehicle interior component of claim 1, wherein the elastomeric material comprises a material having a Durometer of less then approximately 90 Shore A.

9. The illuminated vehicle interior component of claim 1, comprising a printed circuit board (PCB) having the light source electrically coupled thereto.

10. The illuminated vehicle interior component of claim 1, comprising a light guide configured to direct the light from the light source toward the elastomeric material.

11. The illuminated vehicle interior component of claim 1, wherein the elastomeric material is configured to appear dark when not illuminated.

12. The illuminated vehicle interior component of claim 1, wherein the elastomeric material is configured to block movement of objects in contact with the show surface of the support.

13. An illuminated vehicle tray assembly comprising:
a support comprising a show surface, a rear surface, and a plurality of apertures each extending between the rear surface and the show surface;
an elastomeric material disposed in each of the plurality of apertures of the support;
a substrate coupled to the rear surface of the support; and
a light source coupled to the substrate, and configured to direct light toward the elastomeric material;
wherein the elastomeric material is configured to receive light from the light source and to direct the light through the elastomeric material from the rear surface to the show surface.

14. The illuminated vehicle tray assembly of claim 13, wherein the elastomeric material comprises an injection molded elastomer.

15. The illuminated vehicle tray assembly of claim 13, wherein the light source comprises a light emitting diode (LED).

16. A method for manufacturing an illuminated vehicle interior component, comprising:
forming a plurality of apertures in a support; and
injection molding an elastomeric material configured to be disposed in the plurality of apertures, wherein the elastomeric material is configured to receive light from a light source and to direct the light through the elastomeric material from a rear surface of the support to a show surface of the support.

17. The method of claim 16, comprising tinting the elastomeric material with a light transmissive tint.

18. The method of claim 16, comprising coupling a substrate to the rear surface of the support.

19. The method of claim 18, comprising coupling a printed circuit board (PCB) to the substrate, wherein the PCB comprises a light source configured to emit the light toward the elastomeric material.

20. The method of claim 19, comprising disposing a light guide between the light source and the elastomeric material to direct the light from the light source toward the elastomeric material.
